(19) United States
(12) Patent Application Publication
(10) Pub. No.: US 2026/0370664 A1
(43) Pub. Date: Nov. 19, 2026

(54) CYBERSECURITY MODELING FOR ONLINE SEQUENCES

(71) Applicant: BANK OF MONTREAL, Toronto (CA)

(72) Inventors: Raman Preet SINGH, Kitchener (CA); Scott Alois PLASTINE, Port Washington, WI (US); Laura Andrea HARRIS, Toronto (CA); Rachel BILLINGS, Toronto (CA); Mangesh BHANGARE, Toronto (CA); Amritraj Pankajakshan NAIR, Toronto (CA)

(73) Assignee: BANK OF MONTREAL, Toronto (CA)

(21) Appl. No.: 19/671,746

(22) Filed: May 8, 2026

Related U.S. Application Data
(60) Provisional application No. 63/808,104, filed on May 19, 2025.

(51) Int. Cl. H04L 9/40; H04L 41/16; H04L 41/22

(52) U.S. Cl. CPC H04L 63/1416; H04L 41/16; H04L 41/22

(57) ABSTRACT

The technical solutions described herein aim to use computer models to analyze behavior by tracking URL sequences visited during a computing session. The technical solutions described herein can receive a collection of interactions with one or more applications executing on a user interface of a computer, laptop, terminal, or other computing device to identify a baseline of typical user activity. The technical solutions described herein can compare suspicious patterns against the baseline to identify one or more anomalies. The suspicious patterns can include unusual URL transitions or repeated access attempts and the technical solutions described herein can alert the computing device of the suspicious attack pattern. Furthermore, the technical solutions described herein can improve detection of the anomalies by incorporating behavioral analytics, IP address, and device metadata.

### CROSS-REFERENCE TO RELATED APPLICATIONS

This application claims priority to U.S. Provisional Patent Application No. 63/808,104, filed May 19, 2025, which is incorporated by reference in its entirety.

### TECHNICAL FIELD

This application relates generally to using neural networks to identify malicious activities by analyzing user behavior patterns.

### BACKGROUND

Conventional solutions that are used to identify malicious activities typically involve using firewalls and uniform resource locators (URLs). However, these conventional solutions often fall short due to a limited ability to detect unknown threats and malicious attacks that mimic user behavior. Firewalls cannot adapt to the dynamic nature of malicious attacks, such as zero day threats, and the emerging technologies of artificial intelligence. Furthermore, the conventional solutions may use behavioral analytics that monitor and manage internet protocol (IP) addresses and user activities to identify anomalies. However, using behavioral analytics alone leads to an increased number of false positives, missed attack patterns, and inconsistent detection of the attacks. As a result, many organizations may be left vulnerable to advanced persistent threats.

### SUMMARY

To address the shortcomings described above, the technical solutions described herein aim to use computer models to analyze behavior by tracking URL sequences visited during a computing session. The technical solutions described herein can receive a collection of interactions with one or more applications executing on a user interface of a computer, laptop, terminal, or another computing device to identify a baseline of typical user activity. The technical solutions described herein can compare suspicious patterns against the baseline to identify one or more anomalies. The suspicious patterns can include unusual URL transitions or repeated access attempts and the technical solutions described herein can alert the computing device of the suspicious attack pattern. Furthermore, the technical solutions described herein can improve detection of the anomalies by incorporating behavioral analytics, IP address, and device metadata.

The disclosed methods and systems provide for detecting zero-day cybersecurity threats by modeling and analyzing sequences of user interactions with websites and web applications (or other electronic platforms). Unlike conventional systems that rely solely on static rules or IP-based heuristics, the methods and systems discussed herein dynamically generate a nodal data structure—such as a Markov chain or neural network—that maps expected user behavior as probabilistic transitions between webpages or interface elements. By comparing real-time interaction sequences from a computing device against this baseline model, the system (one or more processors monitoring users interacting with the platform) assigns a variance-based score to identify anomalous behavior indicative of potential malicious activity. When the variance score exceeds a threshold, the system can trigger an alert, interrupt user access, and present one or more authentication challenges to verify the user’s identity. This approach allows for adaptive, session-aware threat detection that enhances system security against sophisticated attacks, including zero-day exploits that attempt to mimic legitimate user behavior.

The systems and methods discussed herein improve upon conventional cybersecurity systems in several ways. Traditional approaches often rely on static rule sets, signature-based detection, or coarse-grained indicators such as IP address blacklisting and heuristic anomaly flags, which are limited in their ability to detect sophisticated or novel threats—especially zero-day attacks that exploit unknown vulnerabilities or mimic legitimate user behavior. These conventional systems frequently suffer from high false positive rates, inconsistent detection, and poor adaptability to user-specific workflows. In contrast, the disclosed system models interaction behavior at a much finer granularity by building a probabilistic nodal data structure—such as a Markov chain or neural network—that captures the actual sequence and likelihood of user interactions across webpages or application states. This enables real-time, personalized threat detection based on deviations from empirically learned patterns of normal behavior. As a result, the methods and systems discussed herein can detect subtle, previously unseen attack strategies that conventional methods overlook, while reducing false positives by grounding alerts in statistically significant behavioral anomalies. Moreover, the integration of device metadata, browser history, and IP context further enhances the precision and context-awareness of threat assessments, providing a more robust and adaptive defense mechanism for modern digital environments.

In some embodiments, aspects of the present solution described herein relate to a computer implemented method. The method can include receiving, by one or more processors, from a computing device associated with a user, a set of interactions with a website having a plurality of webpages; generating, by the one or more processors, a nodal data structure based on the set of interactions to establish an interaction pattern for the website indicating a sequence of interactions associated with the website, the nodal data structure comprising: a plurality of nodes corresponding to the plurality of webpages of the website; and a plurality of edges interconnecting at least two nodes within the nodal data structure, each of the plurality of edges indicating a probability of an interaction with a subsequent page within the plurality of webpages; receiving, by the one or more processors from the computing device, a second set of interactions with the website; identifying, by the one or more processors using the nodal data structure, a score associated with the second set of interactions based on the probability of the interaction with the subsequent page within the plurality of webpages, the score corresponding to a variance in the interaction pattern by accessing the subsequent page within the plurality of webpages with the probability of interaction not satisfying a threshold; and responsive to the score satisfying a second threshold corresponding to a zero-day threat: transmitting, by the one or more processors to the computing device, an alert to generate a graphical user interface to indicate an occurrence of the zero-day threat; and transmitting, by the one or more processors to the computing device via the graphical user interface, one or more authentication criteria associated with the user.

In some embodiments, the method can include selecting, by the one or more processors from a plurality of sequences of interactions, at least one of the plurality of sequences of interactions as a baseline sequence of interactions using the score. In some embodiments, the method can include generating, by the one or more processors, the sequence of interactions according to the interaction pattern for each of the set of interactions; and storing, by the one or more processors, the sequence of interactions within a database. In some embodiments, the method can include generating, by the one or more processors, a second sequence of interactions according to a second interaction pattern for each of the second set of interactions; identifying, by the one or more processors, that the second interaction pattern of the second sequence of interactions corresponds to the interaction pattern of the sequence of interactions by comparing each of the second set of interactions and each of the set of interactions within the database.

In some embodiments, the score indicates at least one of a presence of the zero-day threat or an absence of the zero-day threat, the variance indicating a deviation between the second interaction pattern and the interaction pattern. In some embodiments, the method can include for each session of the computing device, receiving, by the one or more processors from the computing device, the set of interactions with the website; generating, by the one or more processors, the nodal data structure based on the set of interactions for each session of the computing device; and ranking, by the one or more processors, each set of interactions within the nodal data structure according to the score. In some embodiments, the method can include generating, by the one or more processors, the alert for the computing device, responsive to the score satisfying the second threshold, the alert to interrupt access to the website.

In some embodiments, the method can include receiving, by the one or more processors from the computing device, a browser history and one or more internet protocol (IP) addresses associated with each session of the computing device; generating, by the one or more processors, the nodal data structure based on the set of interactions, the one or more IP addresses associated with each session of the computing device, and the browser history to establish the interaction pattern for the website indicating the sequence of interactions associated with the website; receiving, by the one or more processors from the computing device, a third set of interactions with the website; identifying, by the one or more processors using the nodal data structure, a second score associated with the third set of interactions based on a probability of an interaction with a subsequent page within the plurality of webpages; and responsive to the second score satisfying a second threshold corresponding to the zero-day threat: transmitting, by the one or more processors to the computing device, the alert to generate a graphical user interface to indicate the occurrence of the zero-day threat; and transmitting, by the one or more processors, to the computing device via the graphical user interface, one or more authentication criteria associated with the user.

In some embodiments, the method can include generating, by the one or more processors, a dashboard to monitor interactions at the computing device, the dashboard detecting each interaction on the computing device. In some embodiments, the nodal data structure is at least one of a neural network or an artificial intelligence model.

In another embodiment, a system comprises one or more processors, coupled with memory configured to receive from a computing device associated with a user, a set of interactions with a website having a plurality of webpages; generate a nodal data structure based on the set of interactions to establish an interaction pattern for the website indicating a sequence of interactions associated with the website, the nodal data structure comprising: a plurality of nodes corresponding to the plurality of webpages of the website; and a plurality of edges interconnecting at least two nodes within the nodal data structure, each of the plurality of edges indicating a probability of an interaction with a subsequent page within the plurality of webpages; receive, from the computing device, a second set of interactions with the website; identify, using the nodal data structure, a score associated with the second set of interactions based on the probability of the interaction with the subsequent page within the plurality of webpages, the score corresponding to a variance in the interaction pattern by accessing the subsequent page within the plurality of webpages with the probability of interaction not satisfying a threshold; and responsive to the score satisfying a second threshold corresponding to a zero-day threat: transmit, to the computing device, an alert to generate a graphical user interface to indicate an occurrence of the zero-day threat; and transmit, to the computing device via the graphical user interface, one or more authentication criteria associated with the user.

### BRIEF DESCRIPTION OF THE DRAWINGS

FIG. 1 illustrates components of a threat identification system, according to an embodiment.

FIG. 2 illustrates a flow diagram of a method for identifying threats, according to an embodiment.

FIG. 3 illustrates an example of interactions sequences with an application executing on a computing device, according to an embodiment.

FIG. 4 illustrates an example of a table of scores based on the probabilities of interactions illustrates an example of a process executed within the threat identification system, according to an embodiment.

FIG. 5 illustrates an example nodal data structure generated by the threat identification system, according to an embodiment.

FIG. 6 illustrates an example of a table of probabilities of interactions with a subsequent webpage based on the nodal data structure, according to an embodiment.

FIG. 7 illustrates an example of a process executed within the threat identification system, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

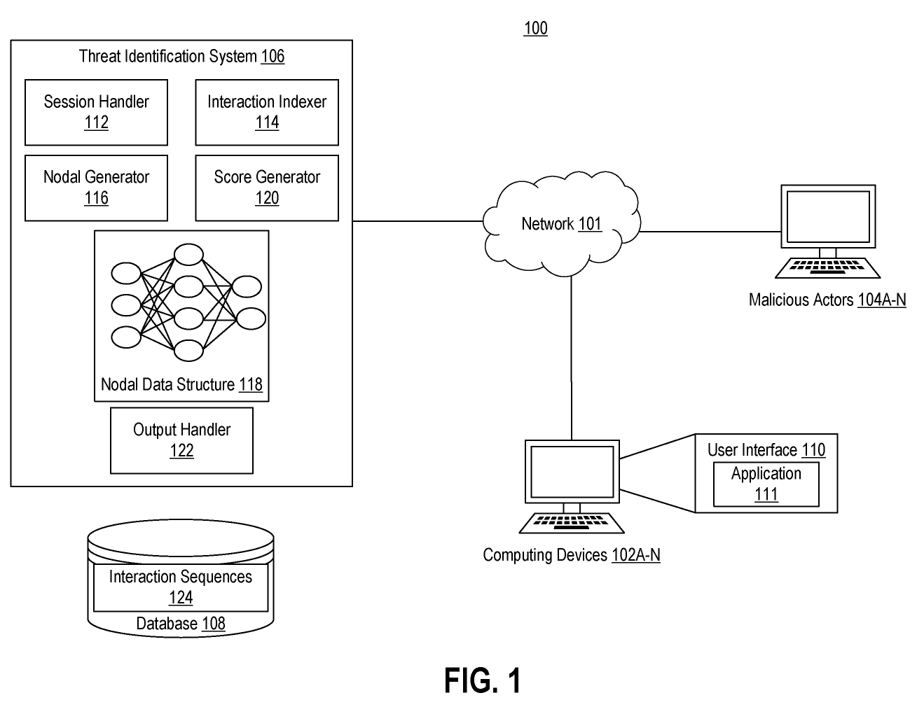

FIG. 1 illustrates components of a threat identification system 100. In an overview, the system 100 can include a plurality of computing devices 102A–N (referred to as computing devices 102 or computing device 102 herein), a plurality of malicious actors 104A–N (referred to as malicious actors 104 herein), and at least one threat identification system 106 in communication with a database 108. The above-mentioned components may be connected to each other through a network 101. Examples of the network 101 may include, but are not limited to, private or public LAN, WLAN, MAN, WAN, and the Internet. The network 101 may include both wired and wireless communications according to one or more standards and/or via one or more transport mediums.

The communication over the network 101 may be performed in accordance with various communication protocols such as Transmission Control Protocol and Internet Protocol (TCP/IP), User Datagram Protocol (UDP), and IEEE communication protocols. In one example, the network 101 may include wireless communications according to Bluetooth specification sets, or another standard or proprietary wireless communication protocol. In another example, the network 101 may also include communications over a cellular network, including, e.g., a GSM (Global System for Mobile Communications), CDMA (Code Division Multiple Access), EDGE (Enhanced Data for Global Evolution) network.

The computing device 102 can be any device comprising one or more processors with memory capable of receiving interactions and selections with a user interface (UI) 110. The UI 110 can display various renderings of application 111 associated with a program of an organization or an entity. The application 111 can include instructions to cause a plurality of UI elements of the UI to generate or render various GUIs including at least one of a website, web browser, office suites, email suites, media players, development tools, communication applications, web applications, among other aspects of the UI 110. The computing device 102 can be at least one of a computer, terminal, laptop, smartphone, desktop, server, mainframe, among others.

The malicious actors 104 can be any device comprising one or more processors with memory capable of performing actions associated with cybersecurity risks at the computing device 102. The malicious actors 104 can be at least one of a computer, terminal, laptop, smartphone, desktop, server, mainframe, among others. In some instances, the malicious actors 104 can interact with the computing device via the network 101 using malicious methods (e.g., hacking, phishing, malware, rootkits, keyloggers, USB flash drives, malware). The malicious actors 104 can use the malicious methods to generate interaction sequences which mimic an interaction sequence of the computing device 102.

The threat identification system 106 can be any computing device comprising one or more processors coupled with memory and software capable of performing the various processes and tasks described herein. The threat identification system 106 can be housed within a computing system (e.g., laptop, PC, smart device), within a server group (e.g., data center, branch office, or server site), or locally on the computing device 102 (e.g., within a browser, within memory) and include instructions to manage interactions at the computing device 102, generate nodal data structures 118, and store interaction sequences. The threat identification system 106 can be in communication with the computing device 102, and the database 108, among others.

In the mitigation system 106, the session handler 112 can monitor, manage, or otherwise initiate sessions at the computing device 102. The session handler 112 can further receive or obtain interactions with the sessions at the computing device 102. The sessions and the interactions can be initiated, sent, or received in accordance with at least one of a software instruction (e.g., C++, Python), instruction execution, memory access, program counter, among others. The sessions and interactions be sent via a system bus or over the network 101.

The interaction indexer 114 can be at least one processor configured to execute instructions to receive, obtain or otherwise manage interactions between a user operating the computing device 102 and the application 111 via the user interface 110. The interaction indexer 114 can generate, determine, or otherwise identify interaction sequences 124 based on the interactions detected via the session at the computing device 102. The interaction indexer 114 can generate the interaction sequences 124 as data structures (e.g., linked list, array, graph, map, etc.)

The nodal generator 116 can be at least one processor configured to execute instructions to generate, determine, or otherwise identify a nodal data structure 118 (e.g., neural network, artificial intelligence model) that uses nodes or neurons, edges (e.g., pointers, references), and layers to organize data associated with a mapping for interactions with a webpage and outputting indications that indicate a violation of the mappings or an anomaly associated with the mapping. The nodal data structure 118 can be at least one of a tree, a linked list, a graph, a feedforward neural network (FNN), a convolutional neural network (CNN), a recurrent neural network (RNN), a generative adversarial neural network (GAN), among other formats for the nodal data structure 118.

The score generator 120 can be at least one processor configured to execute instructions to generate or identify a score for each session at the computing device 102. The score can indicate value based on probabilities for the interaction sequences 124 of the computing device 102. The probabilities can be generated based on each session detected at the computing device 102. The output handler 122 can be at least one processor configured to execute instructions to generate or provide an alert to the computing device 102. The alert can be a notification, a popup, an interrupt, an indication, a generated user interface 110, among others.

The database 108 can be structured or unstructured repository to store, manage, and retrieve data associated with the system 100 or the mitigation system 106. The database 108 can be stored locally within the computing device 102 or remotely. The database 108 can be managed by a Database management system (DMBS) and can be at least one of a MySQL, PostgreSQL, NoSQL, among other databases. The database 108 can include a plurality of interaction sequences 124 associated with a responsive computing device 102.

The system 100 is not confined to the components described herein and may include additional or alternate components, not shown for brevity, which are to be considered within the scope of the embodiments described herein.

The session handler 112 can receive login criteria entered into the user interface 110 of the application 111 at the computing device 102. The login criteria can include one or more authentication inputs associated with a user account. The authentication inputs can include a username, a password, a one-time code, multi-factor authentication data, biometric information, or other credentials used to initiate access to the application 111. In some implementations, the session handler 112 can receive the login criteria by monitoring one or more input fields, buttons, or other graphical user interface elements presented by the user interface 110. For example, the session handler 112 can detect entry of a username into a first input field, detect entry of a password into a second input field, and detect selection of a login button to indicate submission of the login criteria for processing.

The session handler 112 can establish a network session for the computing device 102 in response to receiving the login criteria for the user. The network session can correspond to a bounded interval of activity associated with authenticated or attempted access to the website through the application 111. In some implementations, the session handler 112 can establish the network session by validating the login criteria, assigning a session identifier, recording a timestamp, and associating subsequent interactions of the computing device 102 with the session identifier. The network session can remain active until a logout event, a timeout event, or another session-termination condition occurs. For example, the session handler 112 can create a first session record at a first timestamp after receiving valid login credentials.

The session handler 112 can receive, from the computing device 102 associated with the user during the network session, a plurality of network operations indicating a set of interactions with a website. The plurality of network operations can include requests, responses, page transitions, link selections, form submissions, button activations, authentication attempts, application programming interface calls, or other activities occurring while the network session is active. In some implementations, the session handler 112 can receive the plurality of network operations from event logs, browser telemetry, application telemetry, session cookies, request headers, or other data generated at the computing device 102 or exchanged over the network 101. The session handler 112 can organize the plurality of network operations according to the active network session so the plurality of network operations are associated with a common set of interactions. For example, the plurality of network operations can include a login request, a step-up authentication request, a transition to an account overview page, and a transition to a transaction-history page within a single session of the computing device 102.

The session handler 112 can generate a dashboard to monitor interactions at the computing device 102. The dashboard can include a graphical interface, a monitoring panel, or another presentation layer that displays information associated with one or more network sessions, detected interactions, anomaly scores, or alert conditions. In some implementations, the session handler 112 can generate the dashboard by collecting interaction data from the computing device 102, formatting the interaction data into visual elements, and updating the visual elements in response to additional network operations detected during the network session. The dashboard can present counts of sessions, ordered interaction sequences, timestamps, status indicators, or anomaly flags associated with one or more sessions. For example, the dashboard can display a first panel showing active sessions, a second panel showing a sequence of webpage transitions for a selected session, and a third panel showing whether a score associated with that session satisfies a threshold corresponding to a zero-day threat.

The session handler 112 can detect, using one or more graphical user interface elements, the plurality of network operations to generate a sequence of interactions within the network session. The one or more graphical user interface elements can include input fields, hyperlinks, menus, tabs, buttons, dialog boxes, selectable icons, or other interactive elements rendered by the application 111. In some implementations, the session handler 112 can detect the plurality of network operations by monitoring events generated when a user interacts with the one or more graphical user interface elements, and can arrange the detected events in temporal order to generate the sequence of interactions for the network session. The sequence of interactions can reflect an order in which webpages, interface states, or functions of the website are accessed during the network session. For example, the session handler 112 can detect selection of a login button, detect a transition to a step-up authentication page, detect navigation to an account overview page, and detect navigation to a history page, and can store the detected operations as an ordered sequence of interactions for that network session.

The interaction indexer 114 can identify, based on the set of interactions, an interaction pattern for the website that indicates the sequence of interactions within the network session. The interaction pattern can reflect an arrangement or order of webpage accesses that occur during the network session. In some implementations, the interaction indexer 114 can identify the interaction pattern by extracting a temporal or spatial ordering of the plurality of network operations and mapping each operation to a corresponding page identifier within the website. For example, the interaction indexer 114 can identify that a particular session includes a login operation followed by an authentication operation, followed by an account overview operation, and followed by a transaction-history operation, and can represent that ordering as the interaction pattern for that session.

The interaction indexer 114 can select, from a plurality of sequences of interactions, at least one sequence of interactions as a baseline sequence of interactions using a score that satisfies a truth threshold. The truth threshold can correspond to a minimum probability indicating that a sequence of interactions occurs with a sufficient frequency to be representative of common user behavior. In some implementations, the interaction indexer 114 can select the baseline sequence of interactions by ranking each sequence of interactions according to the score and selecting a highest-ranked sequence or a sequence whose score satisfies the truth threshold. For example, the interaction indexer 114 can select a first sequence of interactions as the baseline sequence of interactions when the first sequence of interactions occurs in seventy-five percent of observed sessions.

The interaction indexer 114 can generate the sequence of interactions according to the interaction pattern for the set of interactions. The sequence of interactions can correspond to an ordered list of webpage identifiers, state identifiers, or operation identifiers derived from the interaction pattern. In some implementations, the interaction indexer 114 can generate the sequence of interactions by extracting each operation identifier from the interaction pattern and arranging the operation identifiers in temporal order. For example, the interaction indexer 114 can generate a sequence of interactions that includes a login identifier, a step-up identifier, an account overview identifier, and a transaction-history identifier, arranged in that order, based on the interaction pattern observed during the network session.

The session handler 112 can receive, from the computing device 102, a browser history and an internet protocol address associated with the network session of the computing device 102. The browser history can include a list of webpages previously visited by the computing device 102 prior to or during the network session. The internet protocol address can identify a network location or origin of the computing device 102 during the network session. In some implementations, the session handler 112 can receive the browser history and the internet protocol address by querying the computing device 102 or by receiving telemetry data transmitted by the computing device 102 during the network session.

The interaction indexer 114 can store the sequence of interactions in the database 108. In some implementations, the interaction indexer 114 can store the sequence of interactions by generating a record that associates the sequence of interactions with a session identifier, a user identifier, a timestamp, or other session metadata, and can insert the record into the database 108. For example, the interaction indexer 114 can store a record that includes the sequence of interactions, a session identifier of “session_12345,” a user identifier of “user_67890,” and a timestamp indicating the start time of the network session.

The nodal generator 116 can generate a nodal data structure 118 that corresponds to a mapping between each of the plurality of network operations and the sequence of interactions within the network session. The nodal data structure 118 can include a plurality of nodes and a plurality of edges that represent transitions among webpages or interface states. In some implementations, the nodal generator 116 can generate the nodal data structure 118 by creating a node for each unique webpage or operation observed in the sequence of interactions and creating an edge between two nodes when a transition from one webpage to another webpage is observed in the sequence of interactions. For example, the nodal generator 116 can create a first node representing a login page, a second node representing an account overview page, and an edge connecting the first node to the second node to represent a transition from the login page to the account overview page.

The nodal generator 116 can generate the nodal data structure 118 to include a plurality of nodes corresponding to each of the plurality of network operations for the website. Each node in the plurality of nodes can represent a distinct webpage, interface state, or operation that a user can access or perform during a network session. In some implementations, the nodal generator 116 can generate the plurality of nodes by extracting unique identifiers from the plurality of network operations and creating a node for each unique identifier. For example, the nodal generator 116 can generate a first node for a login page, a second node for an authentication page, a third node for an account overview page, and a fourth node for a transaction-history page.

The nodal generator 116 can generate the nodal data structure 118 to include a plurality of edges interconnecting at least two nodes within the nodal data structure 118. Each edge in the plurality of edges can represent a transition from one node to another node. In some implementations, the nodal generator 116 can generate the plurality of edges by identifying each pair of consecutive operations in the sequence of interactions and creating an edge between the corresponding nodes for each identified pair. For example, the nodal generator 116 can create a first edge connecting a first node representing a login page to a second node representing a step-up authentication page, and can create a second edge connecting the second node to a third node representing an account overview page.

The nodal generator 116 can assign, to each of the plurality of edges, a probability of an interaction with a respective webpage within a plurality of webpages of the website. The probability of an interaction can indicate a likelihood that a user will transition from one webpage to another webpage during a network session. In some implementations, the nodal generator 116 can assign the probability of an interaction by counting the number of times a transition from a first webpage to a second webpage occurs across all observed sessions and dividing that count by the total number of transitions from the first webpage to any webpage. For example, the nodal generator 116 can assign a probability of 0.75 to an edge connecting a login page to an account overview page when the transition from the login page to the account overview page occurs in seventy-five of one hundred observed sessions that start at the login page.

The nodal generator 116 can generate the nodal data structure 118 based on the set of interactions, the internet protocol address associated with the network session, and the browser history to establish the interaction pattern for the website. In some implementations, the nodal generator 116 can generate the nodal data structure 118 by incorporating the internet protocol address and the browser history as additional features that influence the probabilities assigned to the plurality of edges. For example, the nodal generator 116 can assign a higher probability to an edge connecting a login page to a step-up authentication page when the internet protocol address associated with the network session originates from a geographic region associated with elevated security risk, or can assign a lower probability to that edge when the browser history indicates that the computing device 102 has previously accessed the website from a trusted location.

The nodal generator 116 can generate the nodal data structure 118 as at least one of a neural network or an artificial intelligence model. In some implementations, the nodal generator 116 can generate the nodal data structure 118 as a feedforward neural network, a convolutional neural network, a recurrent neural network, or another type of neural network that maps input sequences to output probabilities. For example, the nodal generator 116 can generate the nodal data structure 118 as a recurrent neural network that receives a sequence of webpage identifiers as input and outputs a probability distribution over possible next webpages for each step in the sequence.

The session handler 112 can establish, at a second timestamp, a second network session for the computing device 102 in response to receiving login criteria for the user. The second network session can correspond to a second bounded interval of activity that is distinct from a first network session established at a first timestamp. In some implementations, the session handler 112 can establish the second network session by validating the login criteria, assigning a second session identifier, recording the second timestamp, and associating subsequent interactions of the computing device 102 with the second session identifier. For example, the session handler 112 can establish a first network session at a first timestamp of 10:00 AM and can establish a second network session at a second timestamp of 2:00 PM, after receiving valid login credentials at each respective timestamp.

The session handler 112 can receive, from the computing device 102 during the second network session, the plurality of network operations indicating a second set of interactions with the website. The second set of interactions can differ from a first set of interactions received during a first network session. In some implementations, the session handler 112 can receive the plurality of network operations from event logs, browser telemetry, or application telemetry associated with the second network session. For example, the session handler 112 can receive a second set of interactions that includes a login operation, a step-up authentication operation, a sensitive information access operation, and a password change operation, whereas a first set of interactions received during a first network session includes a login operation, a step-up authentication operation, an account overview operation, and a transaction-history operation.

The interaction indexer 114 can generate a second sequence of interactions based on the plurality of network operations within the second network session. The second sequence of interactions can reflect an order of webpage accesses or operations performed during the second network session. In some implementations, the interaction indexer 114 can generate the second sequence of interactions by extracting a temporal ordering of the plurality of network operations during the second network session and mapping each operation to a corresponding state or page identifier. For example, the interaction indexer 114 can generate a second sequence of interactions that includes a login identifier, a step-up identifier, a sensitive information identifier, and a password change identifier, arranged in that order.

The interaction indexer 114 can identify that a second interaction pattern of the second sequence of interactions does not match the interaction pattern of the sequence of interactions by comparing the second sequence of interactions and the sequence of interactions. The second interaction pattern can differ from a first interaction pattern when the order, type, or frequency of operations in the second sequence of interactions diverges from the order, type, or frequency of operations in a first sequence of interactions. In some implementations, the interaction indexer 114 can identify that the second interaction pattern does not match the interaction pattern by performing a pairwise comparison of each operation in the second sequence of interactions against each operation in the sequence of interactions and detecting that one or more operations differ between the two sequences. For example, the interaction indexer 114 can identify that a second interaction pattern includes a sensitive information access operation that does not appear in a first interaction pattern, and can determine that the second interaction pattern does not match the first interaction pattern based on the sensitive information access.

The nodal generator 116 can generate the nodal data structure 118 for the second network session based on the second set of interactions of the computing device 102. In some implementations, the nodal generator 116 can generate the nodal data structure 118 for the second network session by creating nodes and edges that correspond to the second set of interactions and assigning probabilities to the edges based on the frequency of transitions observed in the second set of interactions. For example, the nodal generator 116 can generate a nodal data structure 118 that includes a first node for a login page, a second node for a sensitive information page, and an edge connecting the first node to the second node with a probability of 1.0 when the second set of interactions includes a single transition from the login page to the sensitive information page.

The score generator 120 can identify, using the nodal data structure 118, a score associated with the second set of interactions based on the probability of the interaction with the respective webpage within the plurality of webpages. The score can quantify a likelihood or anomaly level of the second set of interactions relative to expected interaction patterns represented by the nodal data structure 118. In some implementations, the score generator 120 can identify the score by computing a product of the probabilities associated with each edge traversed in the second sequence of interactions and assigning the product as the score. For example, the score generator 120 can identify a score of 0.01 for a second set of interactions that includes a transition from a login page to a sensitive information page with a probability of 0.1 and a transition from the sensitive information page to a password change page with a probability of 0.1.

The score generator 120 can determine that the score corresponds to a variance in the interaction pattern when access to the respective webpage occurs with the probability of the interaction not satisfying a threshold. The threshold can indicate a minimum probability below which a transition is considered anomalous or indicative of a potential threat. In some implementations, the score generator 120 can determine that the score corresponds to a variance by comparing the probability of the interaction to the threshold and determining that the probability of the interaction is less than the threshold. For example, the score generator 120 can determine that a transition from a login page to a sensitive information page with a probability of 0.05 corresponds to a variance when the threshold is set to 0.1.

The score generator 120 can determine that the score indicates at least one of a presence of the zero-day threat or an absence of the zero-day threat, the variance of the score indicating a deviation between the second interaction pattern and the interaction pattern. The presence of the zero-day threat can be indicated when the score satisfies a second threshold corresponding to a high anomaly level. The absence of the zero-day threat can be indicated when the score does not satisfy the second threshold. In some implementations, the score generator 120 can determine that the score indicates the presence of the zero-day threat by comparing the score to the second threshold and determining that the score is less than the second threshold. For example, the score generator 120 can determine that a score of 0.001 indicates the presence of the zero-day threat when the second threshold is set to 0.01.

The score generator 120 can rank the set of interactions and the second set of interactions within the nodal data structure 118 according to the score. The ranking can order each set of interactions from highest score to lowest score or from lowest anomaly level to highest anomaly level. In some implementations, the score generator 120 can rank the set of interactions by assigning a rank value to each set of interactions based on the score and sorting the sets of interactions according to the rank values. For example, the score generator 120 can assign a first rank to a first set of interactions with a score of 0.5, a second rank to a second set of interactions with a score of 0.01, and a third rank to a third set of interactions with a score of 0.8, and can order the sets of interactions as third, first, second based on the assigned ranks.

The session handler 112 can receive, from the computing device 102, the plurality of network operations indicating a third set of interactions with the website. The third set of interactions can occur during a third network session or during the second network session. In some implementations, the session handler 112 can receive the plurality of network operations from event logs, browser telemetry, or application telemetry associated with the third set of interactions. For example, the session handler 112 can receive a third set of interactions that includes a login operation, a step-up authentication operation, an account overview operation, and a transaction-history operation.

The score generator 120 can identify, using the nodal data structure 118, a second score associated with the third set of interactions based on a probability of an interaction with a respective webpage within the plurality of webpages of the website. In some implementations, the score generator 120 can identify the second score by computing a product of the probabilities associated with each edge traversed in a third sequence of interactions derived from the third set of interactions. For example, the score generator 120 can identify a second score of 0.5625 for a third set of interactions that includes a transition from a login page to an account overview page with a probability of 0.75 and a transition from the account overview page to a transaction-history page with a probability of 0.75.

The score generator 120 can determine that the second score does not satisfy a second threshold corresponding to the zero-day threat. In some implementations, the score generator 120 can determine that the second score does not satisfy the second threshold by comparing the second score to the second threshold and determining that the second score is greater than or equal to the second threshold. For example, the score generator 120 can determine that a second score does not satisfy a second threshold of when the second score is greater than the second threshold.

The output handler 122 can assign a flag to the third set of interactions indicating that the third set of interactions matches the set of interactions. The flag can indicate that the third set of interactions conforms to expected behavior patterns and does not warrant further investigation or alert generation. In some implementations, the output handler 122 can assign the flag by storing a flag value in association with the third set of interactions in the database 108. For example, the output handler 122 can assign a flag value of “normal” to the third set of interactions to indicate that the third set of interactions matches the set of interactions.

The output handler 122 can transmit, to the computing device 102, an alert to generate a graphical user interface element indicating an occurrence of the zero-day threat. The graphical user interface element can include a notification, a popup, a dialog box, or another visual indicator that warns the user of the occurrence of the zero-day threat. In some implementations, the output handler 122 can transmit the alert by generating a message that includes the graphical user interface element and transmitting the message to the computing device 102 over the network 101. For example, the output handler 122 can transmit an alert that includes a popup dialog box displaying the text “Suspicious activity detected. Your session has been interrupted for security reasons.”

The output handler 122 can generate the alert in response to the score satisfying a second threshold corresponding to the zero-day threat. In some implementations, the output handler 122 can generate the alert by creating a message that includes a description of the zero-day threat, a timestamp indicating when the score satisfied the second threshold, and one or more recommended actions for the user to take. For example, the output handler 122 can generate an alert that includes the text “Suspicious activity detected at 2:30 PM on January 1, 2025. Please verify your identity to continue.”

The output handler 122 can block access to the website at the computing device 102 in response to transmitting the alert. Blocking access can prevent the computing device 102 from performing further interactions with the website until one or more authentication criteria are satisfied. In some implementations, the output handler 122 can block access by transmitting an instruction to the computing device 102 to disable one or more graphical user interface elements of the user interface 110 or by terminating the network session. For example, the output handler 122 can transmit an instruction to the computing device 102 to disable all clickable elements on the website and display the alert until the user completes multi-factor authentication.

The output handler 122 can include, within the alert, instructions to interrupt and block access to the website. The instructions can specify that the computing device 102 should suspend all active operations associated with the website and prevent the user from initiating new operations until the one or more authentication criteria are satisfied. In some implementations, the output handler 122 can include the instructions by embedding executable code or control commands within the alert message that cause the computing device 102 to disable the user interface 110 or redirect the user to an authentication page. For example, the output handler 122 can include instructions in the alert that cause the computing device 102 to display a full-screen overlay that blocks all interactions with the website and prompts the user to enter a one-time code sent to a trusted device.

The output handler 122 can transmit, to the computing device 102 via the graphical user interface, one or more authentication criteria associated with the user to restore access to the website. The one or more authentication criteria can include a username, a password, a one-time code, biometric information, or other credentials that verify the identity of the user. In some implementations, the output handler 122 can transmit the one or more authentication criteria by generating an authentication prompt that displays one or more input fields for the user to enter the credentials and transmitting the authentication prompt to the computing device 102 for rendering in the graphical user interface. For example, the output handler 122 can transmit an authentication prompt that includes a first input field for entering a one-time code and a second input field for entering a biometric fingerprint scan, and can restore access to the website after the computing device 102 receives and validates the entered credentials.

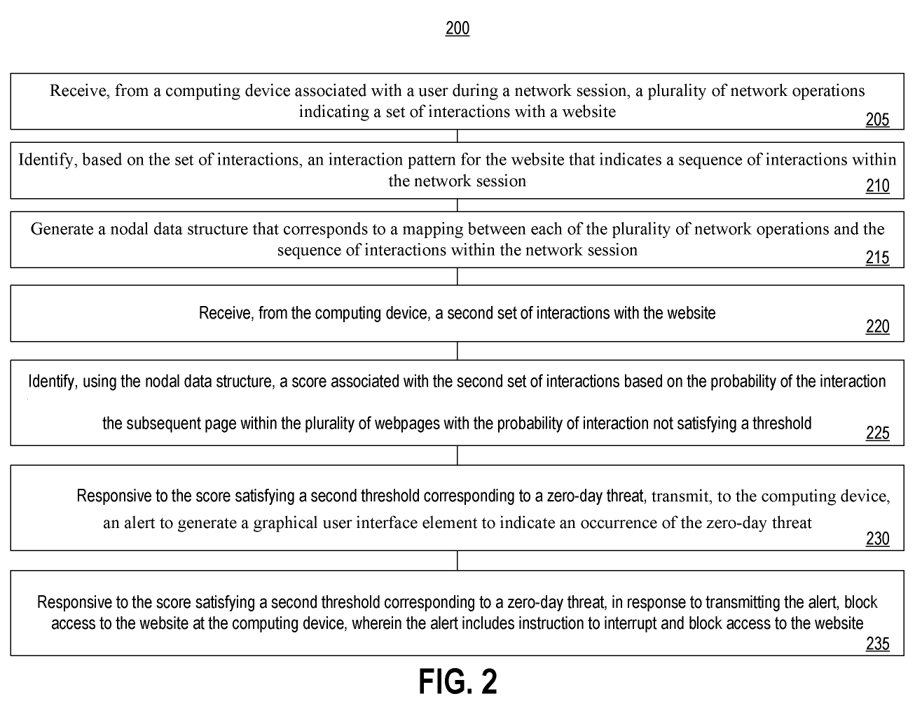

FIG. 2 illustrates a flow diagram of a process executed in the end to end threat modeling system. The method 200 may include steps 205-230. However, other embodiments may include additional or alternative execution steps, or may omit one or more steps (or any part of the steps) altogether. The method 200 is described as being executed by one or more processors (e.g., session handler 112, interaction indexer 114, nodal generator 116, score generator 120, output handler 122) of the threat identification system (e.g., threat identification system 106). However, one or more steps of method 200 may also be executed by any number of computing devices operating in the system 100 described in FIG. 1. For instance, one or more user computing devices may locally perform some or all the steps described in FIG. 2.

At step 205, a session handler (e.g., session handler 112) can receive, from a computing device (e.g., computing device 102) associated with a user, a set of interactions with a website having a plurality of webpages. The session handler can generate a dashboard (e.g., application 111) for display on a UI (e.g., UI 110) on the computing device. The application can be at least one of a generated UI, a website, a web browser, an extension, a web application, a downloadable application, among others. The application can include one or more graphical user interface elements to detect an interaction with the application. The interactions can be at least one of internet protocol (IP) behavior, computing device behavior, or user behavior. The interaction can include navigation inputs, keyboard inputs, button clicks, graphical user interface element interactions, access requests, account logins among other interactions. For example, a user of the computing device can login to a login page of a website. Each field completed within the login page can register as an interaction with the computing device. The login page can be within the dashboard. The IP address of the occurrence of the login can register an as an interaction with the computing device. Upon detection of the interactions, the session handler can receive each of the interactions at the computing device.

In some instances, the threat identification system can be executed within an extension of a browser. The application can monitor interactions with the computing device and detect each interaction at the computing device. The session handler can receive each interaction from the computing device, responsive to the application detecting each interaction. The session handler can cause the computing device to prove information associated with each interaction. The information can include a geolocation of the computing device, the IP address of the computing device, PII, information input into the application. The application can monitor the set of interactions for each session of the computing device. The session can correspond to startup of the dashboard. The session handler can mark or indicate the session based on a detection of a start time of the dashboard. The application can arrange each interaction in the set of interactions based on the session. For example, a first session can include at least four interactions, whereas a second session can include at most two interactions. The interactions of the first session can include “login,” “startup,” “account overview,” “access version history,” whereas the interactions of the second session can include “login” and “step up.”

At step 210, an interaction indexer (e.g., interaction indexer 114) can identify, based on the set of interactions, an interaction pattern for the website that indicates a sequence of interactions within the network session. The interaction indexer can generate, determine, or otherwise identify an interaction pattern for the user. The interaction pattern can be an arrangement or order of interactions that occur during a respective session of the application. The interaction indexer can use the interaction pattern within the session of the application to generate a sequence of interactions (e.g., interaction sequence 124). The interaction sequence can be based on the order of interactions within the interaction pattern.

The interaction indexer can store the interaction sequence in a database (e.g., database 108). In some instances, the interaction indexer can query the database to detect an interaction sequence that include the same set of interactions as the interaction sequence ready to be stored. The query can compare each of the interactions in the second set of interactions and the interactions of the set of interactions. If the interaction indexer detects a match within the database, the interaction indexer can increase a probability or value associated with the respective interaction sequence. As the value of the interaction sequence increases, the interaction indexer can assign the interaction sequence as a baseline interaction sequence. The baseline interaction sequence can correspond to one or more interactions within each session of the application or computing device

At step 215, a nodal generator (e.g., nodal generator 116) can generate a nodal data structure (e.g., nodal data structure 118) based on the set of interactions to establish an interaction pattern for the website indicating a sequence of interactions associated with the website. The nodal generator can generate the nodal data structure according to the interaction sequences. In the context of the systems and methods described herein, the nodal data structure can be a Markov chain, however, the systems and methods are not limited to various other data structures (e.g., linked list, binary tree), artificial intelligence (AI) models, and neural networks (e.g., GAN, ANN). The nodal data structure can include a plurality of nodes, a plurality of edges, and a plurality of layers. Each node of the plurality of nodes can correspond to each webpage of the website (e.g., application 111). Each of webpage can refer to subsequent pages or portions of the application. For example, a first tab of the application can be a first webpage, whereas a second tab of the application can be a second webpage. Therefore, a first node in the nodal data structure can correspond to the first tab of the application and a second node in the nodal data structure can correspond to the second tab of the application.

Each edge can interconnect at least two nodes within the nodal data structure. Each edge can include a probability of an interaction with a subsequent page of within the plurality of webpages. The probability of the interaction can increase based on the occurrence of the subsequent webpage after the previous webpage. The probability of the interaction can decrease based on the non-occurrent of the subsequent webpage after the previous webpage. Each layer in the plurality of layers can correspond to the number of webpages access by a user of the computing device.

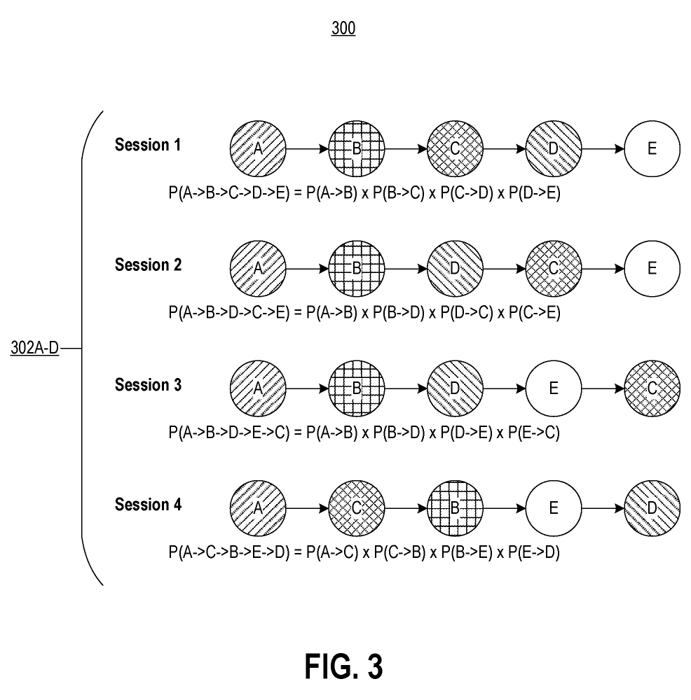

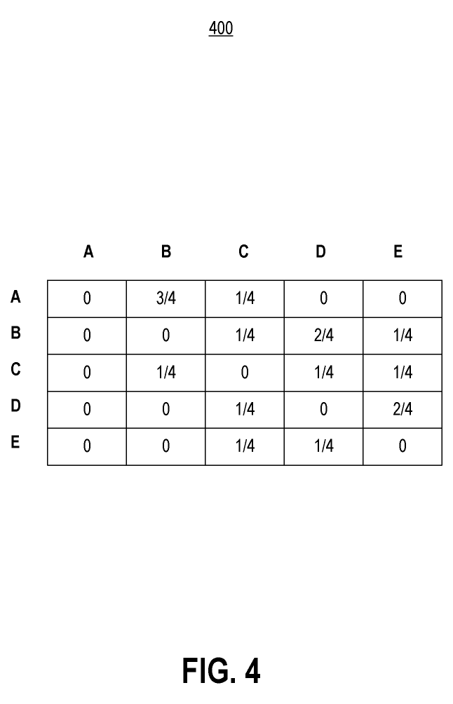

FIG. 3 illustrates an example 300 nodal data structure generated by the threat identification system. In the example 300, the nodal data structure can be represented as a Markov chain, a neural network, a linked list, among other nodal data structures. The threat identification system can generate the nodal data structure according to at least one of log of sums, maximum likelihood estimations, Bayesian estimation or smoothing, expectation-maximization, Gibbs sampling, Laplace smoothing, among other methods. For example, the threat identification system can use log of sums to calculate a sum of paths or sequences for each outcome for a respective input. Each of the paths can be represented as a single Markov chain in a plurality of Markov chains. Each session 302 can be related based on a first node within the nodal data structure. For example, each session 302A–D can start with the same first node (e.g., node A). Each node can correspond to a webpage on a website (e.g., a portion of the application 111). For example, as shown in FIG. 3, node A can be a first webpage, node B can be second webpage, node C can be a third webpage, etc. Each session 302 can include a total probability of occurrence. The total probability of occurrence can be based on a permutation of each probability of interaction assigned to each edge. FIG. 4 illustrates an example of a table 400 of probabilities of interactions with a subsequent webpage based on the nodal data structure as shown in FIG. 3. The interaction indexer can generate the probabilities of interactions based on the interaction sequences stored within the database. For instance, if an interaction sequence occurs in three of the four sessions of a computing device, the interaction indexer can generate the probability of the interaction sequence as ¾, 0.75, or 75% occurrence.

At step 215, the session handler can receive, from the computing device, a second set of interactions with the website or application. The second set of interactions can be the same as the set of interactions. The second set of interactions can be different from the set of interactions. The second set of interactions can correspond to a different session from the first session including the set of interactions. For example, a first session can correspond to a login page and account information, whereas a second session can correspond to a login page, account information, and database access. The second set of interactions can correspond to the user of the computing device or the malicious actor. If the second set of interactions are different from the first set of interaction, the interaction indexer can generate, determine, or otherwise identify a subsequent interaction pattern for the second set of interactions. The interaction pattern can be an arrangement or order of interactions that occur during a subsequent session of the application. The interaction indexer can use the interaction pattern within the session of the application to generate a second sequence of interactions (e.g., interaction sequence 124). The interaction sequence can be based on the order of interactions within the subsequent interaction pattern. If a plurality of interactions is received by the session handler, the interaction indexer can generate an interaction sequence for each of the plurality of interactions based on each respective interaction pattern.

The interaction indexer can store the interaction sequence in the database. In some instances, the interaction indexer can query the database to detect an interaction sequence that include the same set of interactions as the interaction sequence ready to be stored. If the interaction indexer detects a match within the database, the interaction indexer can increase a probability or value associated with the respective interaction sequence. If the interaction indexer does not detect a match within the database 108, the interaction indexer can decrease a probability associated with the interaction sequence and store the interaction sequence within the database.

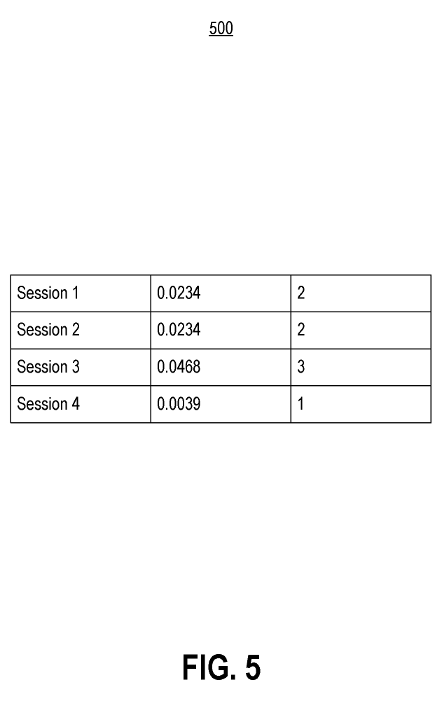

At step 220, a score generator (e.g., score generator 120) can identify, using the nodal data structure, a score associated with the second set of interactions based on the probability of interaction with the subsequent page within the plurality of webpages (e.g., edges of the nodal data structure 118). The score can correspond to a variance or difference indicating a deviation in the interaction pattern and the second interaction pattern. The difference or variance can occur by the malicious actor (e.g., malicious actor 104) accessing the subsequent page within the plurality of webpages with the probability of interaction not satisfying a threshold. The score can range between 0 and 1 as shown in FIG. 5. FIG. 5 illustrates an example of a table 500 of scores based on the probabilities of interactions with subsequent webpages for each session. In some instances, the baseline interaction sequence can be selected using the score assigned to each interaction sequence. As the probability of interactions with the subsequent webpage increase, the score for the interaction sequence increases. The table 500 can further indicate the number of similar outcomes within each stem of the nodal data structure. Each stem of the nodal data structure can correspond to the session. The threshold for the probability can indicate a likelihood for a respective webpage to be accessed. If the probability of an interaction with a subsequent webpage, does not satisfy the threshold, the score generator can flag the set of interactions as possibly malicious activity associated with the computing device. Each of the set of interactions within the nodal data structure can include a rank based on the score.

At step 225, responsive to the score satisfying a second threshold corresponding to a zero day threat, the output handler (e.g., output handler 122) can transmit, to the computing device, an alert to generate a graphical user interface to indicate an occurrence of the zero-day threat. The zero-day threat can indicate a cybersecurity vulnerability that does not have a resolution as it is discovered immediately. The zero-day threat can be initiated by the malicious actor. In some instances, antivirus systems may not detect the threat indicating a high possibility of success for the malicious actor. To provide an indication of the zero-day threat in real time (or near real time), the output handler can determine that the score of the second interaction sequence satisfies the second threshold. The second threshold can indicate a presence of a zero-day threat or an absence of the zero-day threat. If the score satisfies the second threshold, the second set of instructions can correspond to the presence of the zero-day threat. Otherwise, the score can indicate the absence of the zero-day threat.

The output handler can generate the alert in response to the score satisfying the second threshold. The alert can be a notification, a message, a popup, a display, a UI among other forms of alerts. The alert can include the second interaction sequence and, in some cases, the geolocation of the malicious actor 104, the IP address of the malicious actor 104, among other information about the source of the interaction sequence. The alert can indicate the occurrence of the zero-day threat. The alert can further include one or more instructions to generate a UI at the computing device. The output handler can transmit the alert to the computing device. By transmitting the alert, the output handler can provide a simple resolution to protect against the zero day threat by causing the user to provide one or more authorization criteria.

In some embodiments, the alert can include instructions to interrupt access to the website or application. Interrupting access can block a malicious actor from accessing sensitive information (PII) associated with the user. The alert can appear in a portion of the application or on the webpage to warn the user of malicious activity associated with the interaction sequence. The alert can restrict further interactions with the application until the completion of one or more authorization criteria to verify the user.

At step 230, the output handler can concurrently transmit, to the computing device via the graphical user interface, the one or more authentication criteria associated with the user. The output handler can transmit the one or more authentication criteria to the computing device in response to the alert interrupting access to the website or the application. The one or more authentication criteria can include multi-factor authentication (MFA), username and password, a code transmitted to a trusted device (e.g., administrator computing device), a fingerprint, among other authentication criteria. The output handler providing the authentication criteria can verify the user in an attempt to prevent access by the malicious actor 104. In this manner, the systems and methods can generate interaction sequences adaptable to various users of computing devices to detect malicious activity in real time (or near real time). Based on the detection, the systems and methods described herein can notify the user or a server indicating malicious activity associated with the computing device.

### Non-limiting Example

In one non-limiting example, a processor implementing the disclosed system receives a sequence of interactions from a user operating a corporate web application that manages employee payroll and human resources data. During typical sessions, employees in the finance department access the login page, navigate to the payroll dashboard, and then review or update payment records for authorized employee accounts—this sequence is repeatedly observed and stored as a baseline interaction pattern in the system’s nodal data structure. On a subsequent session, the processor detects a different interaction sequence from a user account associated with a contractor role: the user logs in, bypasses the payroll dashboard, and directly attempts to access confidential tax documentation pages typically restricted to HR managers. The nodal data structure identifies that the transition from the login page to the tax document page deviates significantly from any established baseline and assigns a variance score that exceeds the threshold for anomaly detection. In response, the processor triggers an alert, interrupts the session, blocks access to the restricted page, and prompts the user to complete a secondary authentication challenge. This prevents the unauthorized user from accessing sensitive data, while allowing the organization to investigate the suspicious behavior in real time.

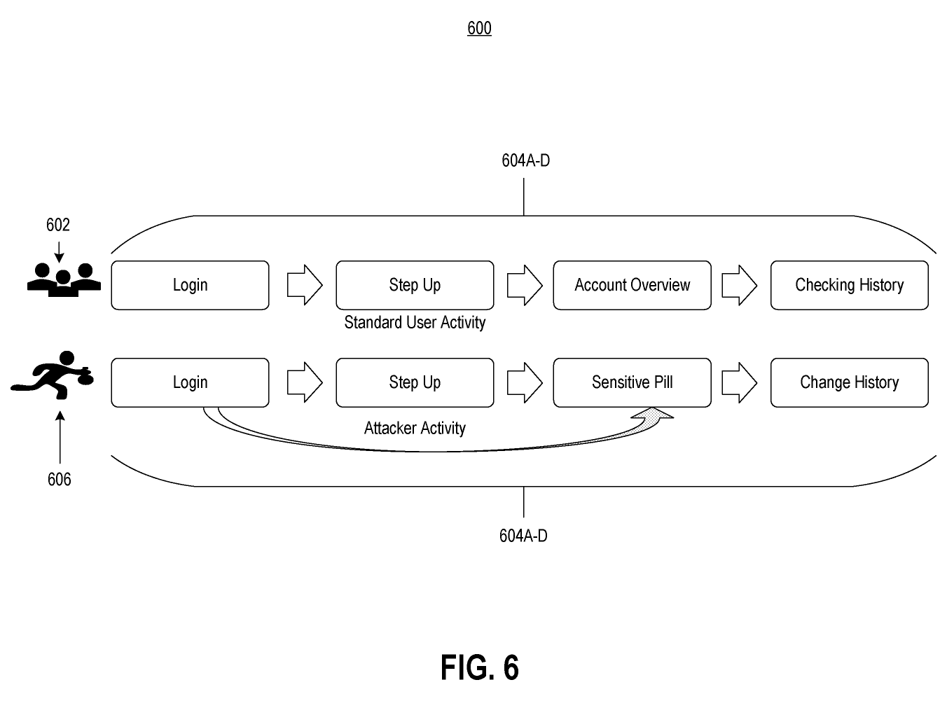

In a non-limiting example, FIG. 6 illustrates an example 600 of interactions sequences (e.g., interaction sequence 124) with an application (e.g., application 111) executing on a computing device (e.g., computing device 102). The application can be a website, a webpage, a web browser, or an electronic application. The example 600 depicts a first interaction sequence 602 and a second interaction sequence 606. The interaction sequence 602 can be performed by a user of the computing device, practitioner, technician, employee, administrator, among others accessing the application. The interaction sequence 606 can be performed by a hacker, breacher, a malicious actor, among others attempting to access the application.

The interaction sequences can be generated by the one or more processors (e.g., session handler, interaction indexer 114). The interaction sequences can be a collection of interactions 604 with the application on the UI (e.g., UI 110) of the computing device. The application can be a website, a browser, a web application, a login page, an electronic form, among other mediums that obtain sensitive data. As shown in FIG. 6, the interaction sequences can correspond to standard user activity 602 (e.g., computing device 102) and attacker activity 606 (e.g., malicious actors 104).

The standard user activity 602 can vary according to the organization associated with the computing device, personal activities conducted by the user (e.g., computing device 102), a configuration of the computing device, among other user activities. Each user activity 602 can correspond to one or more interactions 604 typically detected by the computing device. The interactions 604 can be detected by the threat identification system or the UI on the computing device. The interactions 604 can include logging in and out of systems, accessing organization emails, using communication tools, filing electronic forms, managing files, accessing specializing software, changing passwords, performing multi-factor authentication, accessing remote desktops, installing software updates, software issues, exporting dataset, validating data, among other interactions 604.

As the interactions 604 are detected, the threat identification system 106 can collect the interactions 604 for storage within the database (e.g., database 108) as an interaction sequence for the computing device. The threat identification system can assign at least one interaction sequence within the database as a “baseline interaction sequence” or “standard user activity” 602 by collecting multiple interactions 602 which correspond to a previously stored interaction sequence. For each duplicate interaction sequence, the threat identification system can increase a counter or field value associated with the interaction sequence in the database. The threat identification system can assign the interaction sequence assigned with the highest field value as the baseline interaction sequence 602 or the standard user activity 602. As shown in FIG. 6, the baseline interaction sequence can include “login 604A”, “step up 604B”, “account overview 604C”, and “check history 604C.”

The attacker activity 606 (sometimes referred to as malicious interaction sequence 606) can include a collection of interactions 604’ associated with a malicious actor. The interactions 604’ can be the same as the interactions 604, however, the attacker activity 606 can differ from the standard user activity 602. In some instances, the attacker activity 606 can omit one or more interactions 604 from the standard user activity 602. In some instances, the attacker activity 606 can include one or more interactions 604’ different from the interactions 604 within the standard user activity 602. In some instances, the interactions 604’ can be tailored to sensitive information (e.g., personally identifiable information (PII), account information, password information) associated with the computing device 102). As shown in FIG. 6, the malicious actor 104 can login to an account associated with a user (e.g., login 604A’), access sensitive PII of the user (e.g., sensitive PII 604C’), and attempt to change a password associated with the computing device. Based on a difference in interaction between the attacker activity 606 and the standard user activity 602, the threat identification system can generate an alert for the computing device indicating the presence of a malicious actor.

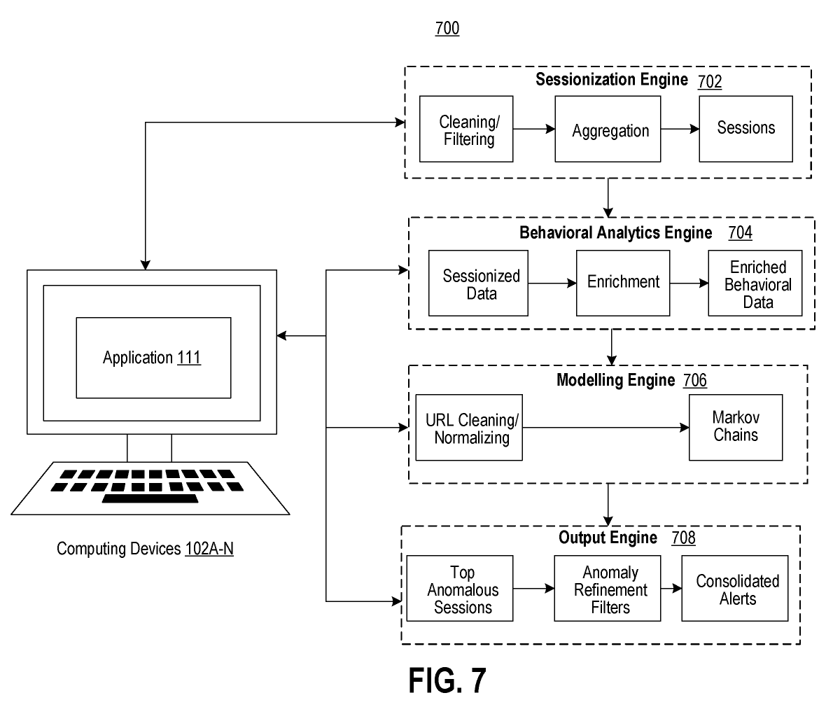

In another non-liming example, FIG. 7 illustrates an example of a process 700 executed within the threat identification system. The process 700 can be executed or performed using the one or more processors (e.g., session handler, interaction indexer 114, nodal generator 116, score generator 120, output handler 122). Under the process 700, a user or practitioner (e.g., technician, software developer, manager, personnel) can interact with an application (e.g., web application, website, web browser, application 111, etc.). Each interaction can correspond to a session at the computing device (e.g., computing device 102). For example, the user can log on to the computing device and browse through electronic documents associated with an organization of the user at a first time indicating a first session. At a second time, the user can log on to the computing device and access payroll data indicating a second session. Each session can be transmitted to a sessionization engine 702 (e.g., session handler 112).

The sessionization engine 702 can obtain, collect, or otherwise receive data associated with the interactions during the session. The data can correspond to interaction data. The sessionization engine 702 can collect data via agent based monitoring, network traffic analysis, log aggregation, security information and event management (SIEM), among other methods of gathering data. The sessionization engine 702 can clean and filter the interaction data by removing duplicate interaction data (e.g., same interaction sequences 124), timestamp normalization, parsing unstructured interaction data, remove non relevant interaction data, including interaction data associated with the user of the computing device, time-window filtering, and resource filtering. Using the clean and filtered data, the sessionization engine 702 can aggregate the data to correspond to a respective session for the computing device. The sessionization engine 702 can provide an indication or a flag to a behavioral analytics engine 704 (e.g., interaction indexer 114) indicating the interaction data for each session (e.g., sessionized data).

The behavioral analytics engine 704 can receive the sessionized data from the sessionization engine 702 or the computing device. The sessionized data from the computing device can correspond to raw data an indicating IP address of the computing device, a geolocation for each session, a role of the user, among other information. Using the sessionized data, the behavioral analytics engine 704 can generate, determine, or otherwise identify enriched behavioral data based on the sessionized data. The enriched behavioral data can correspond to a baseline interaction sequence for the user of the computing device. The baseline interaction sequence can indicate a normal workflow for a user of the computing device. For example, a software developer for an organization may login to the computing device, access a software suite (e.g., Python, C#, Java, Ruby) and an online database to store the code associated with the software suite (e.g., Jira, GitHub, etc.). In some instances, deviations from the baseline interaction sequence can occur during the workflow, however some deviations can indicate suspicious behavior, whereas other deviations can indicate normal behavior. For example, a software developer may access a container that includes code for the software suite instead of the online database which can indicate a normal deviation. The behavioral analytics engine 704 can provide the enriched behavioral data to a modeling engine 706 (e.g., nodal generator 116).

The modeling engine 706 can receive the enriched behavioral data from the behavioral engine and URLs associated with the application from the computing device. The modeling engine 706 can clean and normalize the URLs. Using the clean and normalized URLs and the enriched behavioral data, the modeling engine 706 can generate, determine, or otherwise identify a Markov chain (e.g., nodal data structure 118) identifying one or more interaction sequences for the user of the computing device. Each interaction sequence can include a score that corresponds to a probability of a subsequent webpage (e.g., portion of the application 111) being accessed by the user. The modeling engine 706 can provide the score for each interaction sequence to an output engine 708 (e.g., output handler 122). The output engine 708 can use the score for each interaction sequence to detect or determine anomalies in interaction sequences. The output engine 708 can use the score to rank each session representing an anomaly based on a comparison to the baseline interaction sequences or the Markov chains. The output engine 708 can generate and transmit an alert to the computing device indicating one or more anomalies in the interaction sequences 708.

The systems and methods described herein can improve operation of network-security infrastructure by identifying anomalous session behavior using sequence-aware modeling rather than static rule matching alone. By establishing interaction patterns from network operations, generating a nodal data structure that maps probabilistic transitions between webpages or interface states, and scoring later sessions against that structure, the system can detect subtle deviations that conventional signature-based tools may not identify. The use of session-specific interaction sequences can improve the precision of anomaly detection by evaluating ordered behavior within the context of a user session instead of evaluating isolated events independently. In addition, the system can reduce response latency by generating alerts, interrupting access, and initiating authentication criteria during an active session when the score satisfies a threat threshold. This arrangement can improve technical performance of threat detection and mitigation by increasing detection of previously unseen attack behavior, reducing false positives associated with coarse heuristics, and enabling adaptive, real-time control of access to network resources.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A system for detecting and mitigating zero-day threats during an active network session, the system comprising:
one or more processors; and
a non-transitory memory storing instructions that, when executed by the one or more processors, cause the system to:
receive, from a computing device associated with a user during a network session, a plurality of network operations indicating a set of interactions with a website;
identify, based on the set of interactions, an interaction pattern for the website that indicates a sequence of interactions within the network session;
generate a nodal data structure that corresponds to a mapping between each of the plurality of network operations and the sequence of interactions within the network session, the nodal data structure comprising:
a plurality of nodes corresponding to each of the plurality of network operations for the website; and
a plurality of edges interconnecting at least two nodes within the nodal data structure, each of the plurality of edges indicating a probability of an interaction with a respective webpage within a plurality of webpages of the website;
receive, from the computing device during a second network session, the plurality of network operations indicating a second set of interactions with the website;
identify, using the nodal data structure, a score associated with the second set of interactions based on the probability of the interaction with the respective webpage within the plurality of webpages, the score corresponding to a variance in the interaction pattern by accessing the respective webpage within the plurality of webpages with the probability of the interaction not satisfying a threshold; and
responsive to the score satisfying a second threshold corresponding to a zero-day threat:
transmit, to the computing device, an alert to generate a graphical user interface element to indicate an occurrence of the zero-day threat;
in response to transmitting the alert, block access to the website at the computing device, wherein the alert includes instruction to interrupt and block access to the website.

2. The system of claim 1, the one or more processors are configured to select, from a plurality of sequences of interactions, at least one of the plurality of sequences of interactions as a baseline sequence of interactions using the score that satisfies a truth threshold.

3. The system of claim 1, the one or more processors are configured to:
establish the network session for the computing device, in response to receiving login criteria for the user;
in response to establishing the network session, detect, using one or more graphical user interface elements, the plurality of network operations to generate the sequence of interactions within the network session.

4. The system of claim 3, the one or more processors are configured to:
generate a second sequence of interactions based on the plurality of network operations within a second network session; and
identify that a second interaction pattern of the second sequence of interactions does not match the interaction pattern of the sequence of interactions by comparing each of a second sequence of interactions and each of the sequence of interactions.

5. The system of claim 4, wherein the score indicates at least one of a presence of the zero-day threat or an absence of the zero-day threat, the variance of the score indicating a deviation between the second interaction pattern and the interaction pattern.

6. The system of claim 3,wherein the network session is established at a first timestamp, the one or more processors are configured to:
establish, at a second timestamp, a second network session for the computing device, in response to receiving login criteria for the user;
generate the nodal data structure for the second network session based on the second set of interactions of the computing device; and
rank the set of interactions and the second set of interactions within the nodal data structure according to the score.

7. The system of claim 1, the one or more processors are configured to generate the alert for the computing device, responsive to the score satisfying the second threshold, the alert including instructions to interrupt access to the website.

8. The system of claim 1, the one or more processors to:
receive, from the computing device, a browser history and an internet protocol (IP) addresses associated with the network session of the computing device;
generate the nodal data structure based on the set of interactions, the IP address associated with the network session of the computing device, and the browser history to establish an interaction pattern for the website indicating the sequence of interactions associated with the website;
receive, from the computing device, the plurality of network operations indicating a third set of interactions with the website;
identify, using the nodal data structure, a second score associated with the third set of interactions based on a probability of an interaction with a respective webpage within the plurality of webpages of the website; and
responsive to the second score not satisfying the second threshold corresponding to the zero-day threat, assign a flag to the third set of interactions indicating that the third set of interactions matches the set of interactions.

9. The system of claim 1, the one or more processors are configured to generate a dashboard to monitor interactions at the computing device, the dashboard detecting each interaction on the computing device.

10. The system of claim 1, wherein the nodal data structure is at least one of a neural network or an artificial intelligence model.

11. A method for identifying zero-day threats, comprising:
receiving, by one or more processors from a computing device associated with a user during a network session, a plurality of network operations indicating a set of interactions with a website;
identifying, by the one or more processors based on the set of interactions, an interaction pattern for the website that indicates a sequence of interactions within the network session;
generating, by the one or more processors, a nodal data structure that corresponds to a mapping between each of the plurality of network operations and the sequence of interactions within the network session, the nodal data structure comprising:
a plurality of nodes corresponding to each of the plurality of network operations for the website; and
a plurality of edges interconnecting at least two nodes within the nodal data structure, each of the plurality of edges indicating a probability of an interaction with a respective webpage within a plurality of webpages of the website;
receiving, by the one or more processors from the computing device during a second network session, the plurality of network operations indicating a second set of interactions with the website;
identifying, by the one or more processors using the nodal data structure, a score associated with the second set of interactions based on the probability of the interaction with the respective webpage within the plurality of webpages, the score corresponding to a variance in the interaction pattern by accessing the respective webpage within the plurality of webpages with the probability of the interaction not satisfying a threshold; and
responsive to the score satisfying a second threshold corresponding to a zero-day threat:
transmitting, by the one or more processors to the computing device, an alert to generate a graphical user interface element to indicate an occurrence of the zero-day threat;
in response to transmitting the alert, blocking, by the one or more processors, access to the website at the computing device, wherein the alert includes instructions to interrupt and block access to the website.

12. The method of claim 11, further comprising selecting, by the one or more processors from a plurality of sequences of interactions, at least one of the plurality of sequences of interactions as a baseline sequence of interactions using the score that satisfies a truth threshold.

13. The method of claim 11, further comprising:
establishing, by the one or more processors, the network session for the computing device in response to receiving login criteria for the user; and
in response to establishing the network session, detecting, by the one or more processors using one or more graphical user interface elements, the plurality of network operations to generate the sequence of interactions within the network session.

14. The method of claim 13, further comprising:
generating, by the one or more processors, a second sequence of interactions based on the plurality of network operations within the second network session; and
identifying, by the one or more processors, that a second interaction pattern of the second sequence of interactions does not match the interaction pattern of the sequence of interactions by comparing each of the second sequence of interactions and each of the sequence of interactions.

15. The method of claim 14, wherein the score indicates at least one of a presence of the zero-day threat or an absence of the zero-day threat, the variance of the score indicating a deviation between the second interaction pattern and the interaction pattern.

16. The method of claim 13, wherein the network session is established at a first timestamp, the method further comprising:
establishing, by the one or more processors at a second timestamp, the second network session for the computing device in response to receiving login criteria for the user;
generating, by the one or more processors, the nodal data structure for the second network session based on the second set of interactions of the computing device; and
ranking, by the one or more processors, the set of interactions and the second set of interactions within the nodal data structure according to the score.

17. The method of claim 11, further comprising generating, by the one or more processors, the alert for the computing device responsive to the score satisfying the second threshold, the alert including instructions to interrupt access to the website.

18. The method of claim 11, further comprising:
receiving, by the one or more processors from the computing device, a browser history and an internet protocol (IP) address associated with the network session of the computing device;
generating, by the one or more processors, the nodal data structure based on the set of interactions, the IP address associated with the network session of the computing device, and the browser history to establish the interaction pattern for the website indicating the sequence of interactions associated with the website;
receiving, by the one or more processors from the computing device, the plurality of network operations indicating a third set of interactions with the website;
identifying, by the one or more processors using the nodal data structure, a second score associated with the third set of interactions based on a probability of an interaction with a respective webpage within the plurality of webpages of the website; and
responsive to the second score not satisfying the second threshold corresponding to the zero-day threat, assigning, by the one or more processors, a flag to the third set of interactions indicating that the third set of interactions matches the set of interactions.

19. The method of claim 11, further comprising generating, by the one or more processors, a dashboard to monitor interactions at the computing device, the dashboard detecting each interaction on the computing device.

20. The method of claim 11, wherein the nodal data structure is at least one of a neural network or an artificial intelligence model.
